(19) United States
(12) Patent Application Publication
(10) Pub. No.: US 2007/0109302 A1
(43) Pub. Date: May 17, 2007

(54) Link relationship display apparatus, and control method and program for the link relationship display apparatus

(75) Inventors: Yukihiro Tsuboshita, Kanagawa (JP); Hiroshi Okamoto, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/455,151

(22) Filed: Jun. 19, 2006

(30) Foreign Application Priority Data
Nov. 17, 2005 (JP) 2005-333039

(51) Int. Cl. G06T 11/20

(52) U.S. Cl. 345/440

(57) ABSTRACT

A link relationship display apparatus for displaying a link relationship between first and second node groups, each of which includes at least one node, the link relationship display apparatus includes: a unit to set one of the first and second node groups as a master node group, and another one as a slave node group; a unit to extract a node of an abbreviated display target node group from the slave node group, the node having a degree of link coincidence which exceeds a predetermined threshold, the degree of link coincidence indicating a ratio of a common node to be linked in the master node group; a unit to determine a representative position coordinate of the node of the abbreviated display target node group; and a display unit to display a corresponding abbreviated display target node group in a vicinity of the representative position coordinate.

### BACKGROUND OF THE INVENTION

1. Field of the Invention

The present invention relates to a link relationship display apparatus for displaying a link relationship between nodes, and a control method and a program for the link relationship display apparatus.

2. Description of the Related Art

Recently, networks configured by data consisting of elements and links such as hyperlink relationships in the WWW, and quotation relationships of papers are often visualized, thereby grasping structural characteristics of the networks. In known techniques for visualizing network data, coordinate positions of graphs are calculated by using a dynamic model such as disclosed in JP-A-2004-318739 and Kamada, T., and Kawai, S., “An Algorithm for Drawing General Undirected Graph”, Information Processing Letters, 32, 7-15, 1989.

However, the conventional technique has a following problems: When the scale of a network is enlarged and the number of nodes to be displayed is increased, it is difficult to make a displayed graph visually comprehensive. In addition, when the number of nodes to be displayed increases, the load of calculation of placement coordinates for displaying the nodes disadvantageously increases.

### SUMMARY OF THE INVENTION

The invention has been conducted in view of the above-discussed problems. The invention provides a link relationship display apparatus which can indicate structural characteristics of a network in an easy-to-understand manner even when the number of nodes is increased, and a control method and a program for the link relationship display apparatus.

The invention also provides a link relationship display apparatus in which the load of calculation of placement coordinates when nodes are to be displayed can be reduced, and a control method and a program for the link relationship display apparatus.

According to an aspect of the present invention, a link relationship display apparatus for displaying a link relationship between a first node group and a second node group, each of which includes at least one node, the link relationship display apparatus includes: a unit to set one of the first node group and the second node group as a master node group, and another one as a slave node group; a unit to extract a node of an abbreviated display target node group from the slave node group, the node having a degree of link coincidence which exceeds a predetermined threshold, the degree of link coincidence indicating a ratio of a common node to be linked in the master node group; a unit to determine a representative position coordinate of the node of the abbreviated display target node group; and a display unit to display a corresponding abbreviated display target node group in a vicinity of the representative position coordinate.

According to another aspect of the present invention, a method of controlling a link relationship display apparatus for displaying a link relationship between a first node group and a second node group, each of which includes at least one node, the method includes: setting one of the first node group and the second node group as a master node group, and another one as a slave node group; extracting a nodes of an abbreviated display target node group from the slave node group, the node having a degree of link coincidence which exceeds a predetermined threshold, the degree of link coincidence indicating a ratio of a common node to be linked in the master node group; determining a representative position coordinate of the node of the abbreviated display target node group; and displaying a corresponding abbreviated display target node group in a vicinity of the representative position coordinate.

According to another aspect of the present invention, a storage medium readable by a computer, the storage medium storing a program of instructions executable by the computer to perform a function for controlling a link relationship display apparatus for displaying a link relationship between a first node group and a second node group, each of which includes at least one node, the function includes the steps of: setting one of the first node group and the second node group as a master node group, and another one as a slave node group; extracting a nodes of an abbreviated display target node group from the slave node group, the node having a degree of link coincidence which exceeds a predetermined threshold, the degree of link coincidence indicating a ratio of a common node to be linked in the master node group; determining a representative position coordinate of the node of the abbreviated display target node group; and displaying a corresponding abbreviated display target node group in a vicinity of the representative position coordinate.

### BRIEF DESCRIPTION OF THE DRAWINGS

Embodiments of the present invention will be described in detail based on the following figures, wherein:

FIG. 1 is a diagram of the hardware configuration of a link relationship display apparatus of an embodiment of the invention;

FIG. 2 is a view showing a link relationship between a first node group and a second node group;

FIG. 3 is a diagram showing a network display in the case where all nodes in the first node group and the second node group are directly visualized;

FIG. 4 is a diagram showing a network display in the case where nodes having the same links in the first node group and the second node group are abbreviated and visualized by the link relationship display apparatus;

FIG. 5 is a view showing an abbreviated link relationship;

FIG. 6 is a function block diagram of the link relationship display apparatus;

FIG. 7 is a view showing a table in which each node in a slave node group is handled as a main key and all master nodes to which the node is linked are associated;

FIGS. 8A and 8B are enlarged diagrams showing one of abbreviated display target node groups;

FIG. 9 is a flowchart showing a process in the case where the link relationship display apparatus generates a bipartite graph; and

FIGS. 10A and 10B are diagrams of modifications showing an abbreviated link relationship.

### DETAILED DESCRIPTION OF THE INVENTION

In the invention, the link relationship display apparatus displays a link relationship between first and second node groups each including at least one node, based on information indicating the link relationship between the first and second node groups. The link relationship display apparatus sets one of the first node group and the second node group as a master node group, and sets the other one of the groups as a slave node group. The link relationship display apparatus extracts, from nodes included in the slave node group, nodes having a degree of link coincidence which exceeds a predetermined threshold, the degree of link coincidence indicating a ratio of common nodes in the master node group to be linked. Then, the link relationship display apparatus determines a representative position coordinate for each of the extracted abbreviated display target node groups, and visualizes and displays the link relationship between the first node group and the second node group while placing abbreviated display target node groups in the vicinities of the corresponding representative position coordinates.

According to the invention, even when the number of nodes to be displayed is increased, the link relationship display apparatus can perform the abbreviated display on the set one of the first and second node groups, the one node group having link coincidence with a predetermined ratio or higher. Therefore, structural characteristics of a network can be indicated to the user in an easy-to-understand manner.

In one embodiment of the invention, in predetermined ranges of the determined representative position coordinates, the display means displays corresponding abbreviated display target node groups. By means of the abbreviated display of the abbreviated display target node groups, it is possible to indicate the structural characteristics to the user in an easy-to-understand manner.

In one embodiment of the invention, the display means displays nodes included in the abbreviated display target node groups with being arranged at predetermined intervals. By means of the abbreviated display of the abbreviated display target node groups, it is possible to indicate the structural characteristics to the user in an easy-to-understand manner.

Hereinafter, preferred embodiments of the invention will be described in detail with reference to the accompanying drawings.

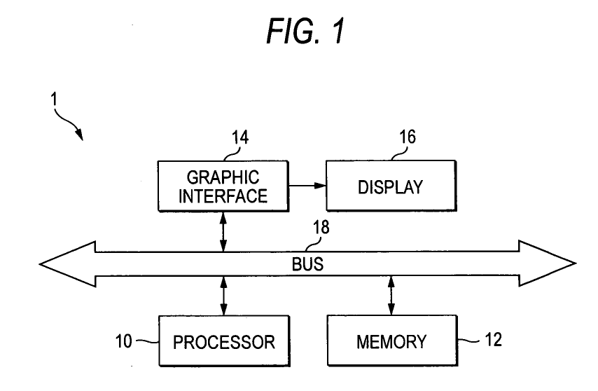

FIG. 1 is a diagram of the hardware configuration of a link relationship display apparatus of an embodiment of the invention. As shown in FIG. 1, the link relationship display apparatus 1 includes a processor 10, a memory 12, a graphic interface 14, and a display 16. The processor 10, the memory 12, and the graphic interface 14 are connected via a bus 18 in a mutually communicable manner. The graphic interface 14 includes a video memory, and transfers generated image data in the video memory to the display 16. The display 16 renders an image on a screen based on the transferred image data.

The link relationship display apparatus 1 performs the visualization of a network configured by a first node group and a second node group based on data indicating a link relationship between the first node group and the second mode group. Hereinafter, description will be made by way of a specific example.

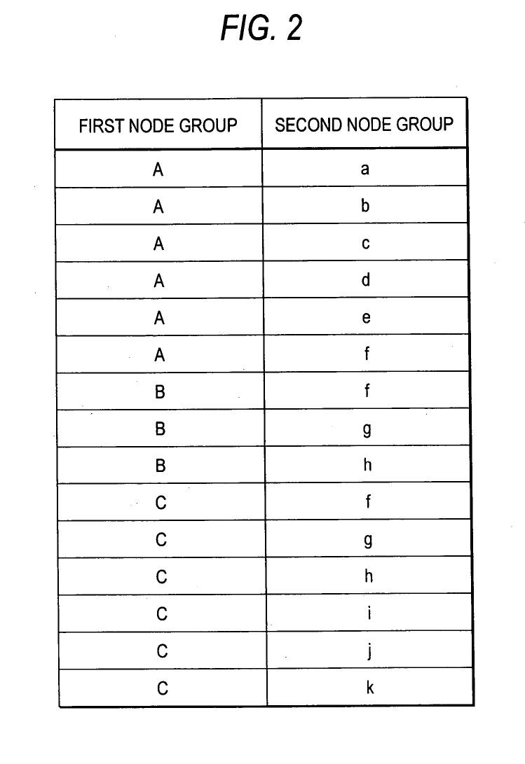

In the specific example used in this embodiment, the first node group includes three nodes {A, B, C}, and the second node group includes eight nodes {a, b, c, d, e, f, g, h}. The first node group and the second node group have a link relationship shown in FIG. 2. In FIG. 2, a correspondence between a node of the first node group and that of the second node group indicates that the nodes have a link relationship.

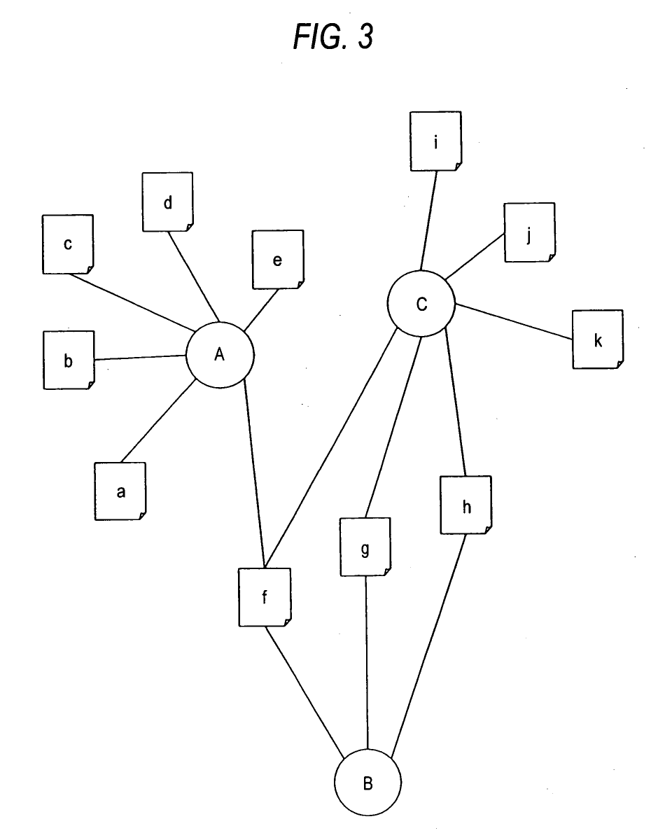

FIG. 3 shows a network display in the case where all the nodes in the first node group and the second node group are directly visualized. In FIG. 3, the nodes of the first node group are indicated by circles, and the nodes of the second node group are indicated by rectangles. In the network display of FIG. 3, when the nodes are automatically arranged into two-dimensional coordinates based on the link information, the known technique disclosed in Kamada, T., & Kawai, S., ibid. is used.

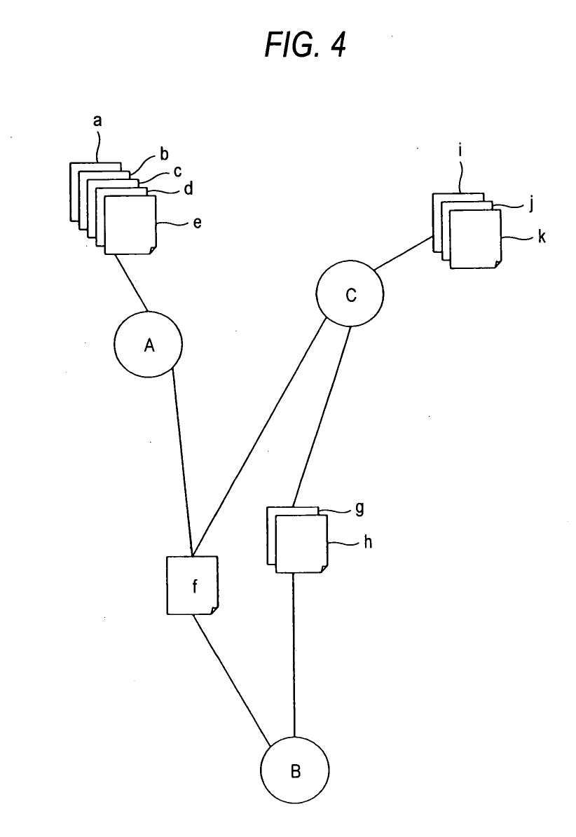

FIG. 4 shows a network display in the case where nodes having the same links in the first node group and the second node group are abbreviated and visualized by the link relationship display apparatus 1 of the embodiment of the invention. In the embodiment, the first node group is fixed, and the second node group is used as an abbreviation display target. Hereinafter, a node group such as the first node group which is not an abbreviation target is referred to as a master node group, and a node group which is an abbreviation target is referred to as a slave node group. In the network display shown in FIG. 4, among the nodes included in the. slave node group {a, b, c, d, e, f, g, h}, nodes which are linked to the same nodes included in the master node group {A, B, C} are abbreviated.

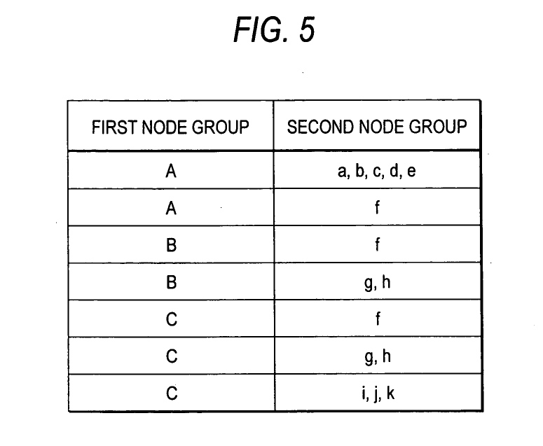

FIG. 5 is a table showing a link relationship of the abbreviated network display. The table of FIG. 5 shows that all the nodes {a, b, c, d, e} of the slave node group have links to the master node A, all the slave nodes {g, h} have links to the master nodes {B, C}, and all the slave nodes {i, j, k} have links to the master node C. The table can be obtained by transforming the table of link relationship shown in FIG. 2 by predetermined processing.

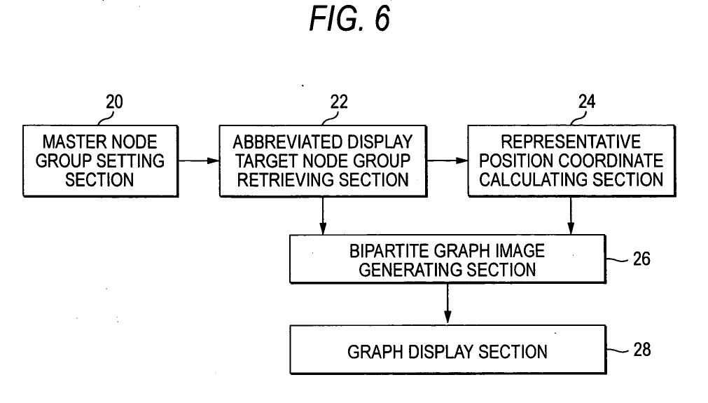

In order to realize the above-described processing, the link relationship display apparatus 1 of the invention has functions which will be described below. FIG. 6 is a function block diagram of the link relationship display apparatus 1 of the invention. As shown in FIG. 6, the link relationship display apparatus 1 includes a master node group setting section 20, an abbreviated display target node group retrieving section 22, a representative position coordinate calculating section 24, a bipartite graph image generating section 26, and a graph display section 28.

The master node group setting section 20 sets one of the first node group and the second node group as a master node group, and sets the other one of the groups as a slave node group. The master node group is a node group which is not an abbreviation target, and the slave node group is a node group which is an abbreviation target. In the setting of the master node group and the slave node group, the first node group may be set as the master node group by default, or the user may specify which one is set as the master node group. Alternatively, the processor 10 may count the number of nodes included in the master/slave node groups, the node group which includes the larger number of nodes may be intended to be set an abbreviation target, the node group including the smaller number of nodes may be set as the master node group, and the other node group may be set as the slave node group. As a method other than the above-mentioned methods, the processor 10 may calculate the number of nodes which can be abbreviated in both cases where the first node group is set as the master node group and where the second node group is set as the master node group, and may set the node group including the smaller number of nodes which can be abbreviated, as the master node group.

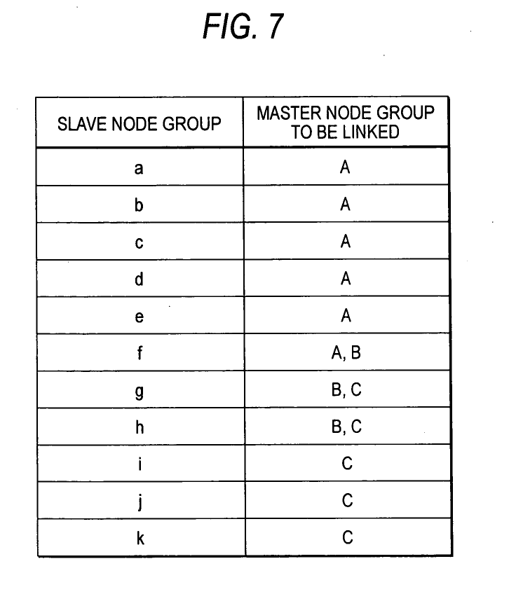

The abbreviated display target node group retrieving section 22 extracts, from the nodes included in the slave node group, nodes having a degree of link coincidence which exceeds a predetermined threshold, as abbreviated display target node groups. The degree of link coincidence indicates a ratio of common nodes in the master node group to be linked. Specifically, the processor 10 generates, on the memory 12, a table shown in FIG. 7 in which each node of the slave node group is handled as a main key, and all the master nodes to which the nodes are linked are associated. Then, the processor 10 refers to the table generated on the memory 12, and retrieves, from the nodes included in the slave node group, nodes having a degree of link coincidence which indicates a ratio of common master nodes to be linked, and which exceeds a predetermined threshold. The degree of link coincidence is obtained by dividing the number of common master nodes to be linked in the master nodes to be linked by two slave nodes to be compared, by the total number of nodes to be linked. A specific example will be described. The slave node a and the slave node b are linked to one common node, the master node A, and the total number of master nodes to be linked is one, so that the degree of link coincidence is 1/1=1. The slave node a and the slave node f are linked to one common node, the master node A, and the total number of master nodes to be linked is three, i.e., the master nodes A, B, C, so that the degree of link coincidence is ⅓. The processor 10 extracts node groups found by the retrieving as abbreviated display target node groups. In the embodiment, the threshold is set to 1, and slave nodes which are completely coincident in linked master node are extracted as abbreviated display target node groups. In the example of FIG. 7, the node group {a, b, c, d, e} is linked to the node A, the node group {g, h} is lined to the node {B, C}, and the node group {i, j, k} is linked to the node C, and therefore the node groups are extracted as abbreviated display target node groups.

The representative position coordinate calculating section 24 handles a node group retrieved by the abbreviated display target node group retrieving section 22 as one node, and calculates representative position coordinates of node groups. The processor 10 regards an abbreviated display target node group obtained by the abbreviated display target node group retrieving section 22 as one node, and calculates the coordinate positions of the nodes. The example used in the embodiment will be described. Each of the node groups {a, b, c, d, e}, {g, h}, and {i, j, k} is regarded as one node, and two-dimensional coordinate values for placing the respective nodes are calculated. The calculated two-dimensional coordinate values are set as the representative position coordinates of the abbreviated display target node groups. In the calculation of the two-dimensional coordinate values, the technique of calculating coordinates of a node based on the dynamic model described in Kamada, T., & Kawai, S., ibid. is used.

The bipartite graph image generating section 26 generates an output image obtained by visualizing the network data, on the basis of the position coordinates of the nodes calculated by the representative position coordinate calculating section 24. A node which is not an abbreviation display target is processed in the same manner as in the case where the abbreviation is not performed, and hence its description is omitted.

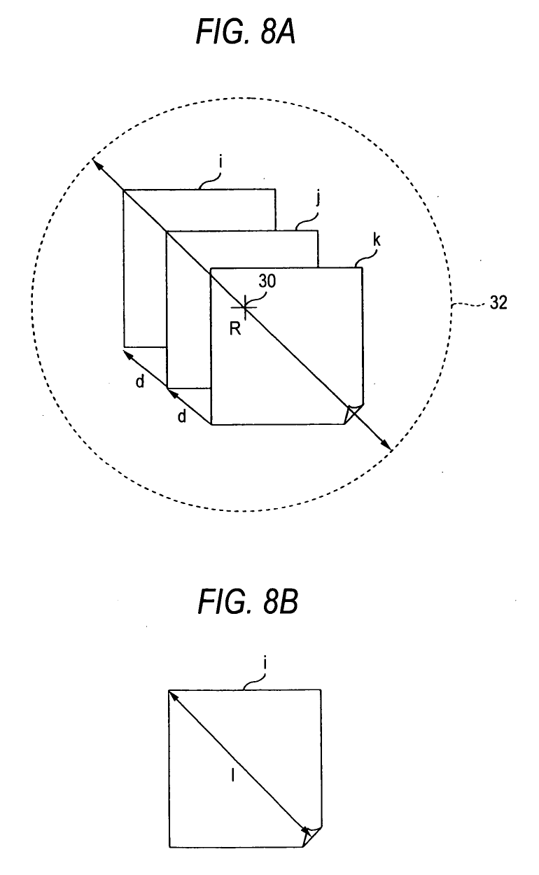

The production of a display image of an abbreviated display target node group will be described with reference to FIGS. 8A and 8B. FIG. 8A is an enlarged diagram of the abbreviated display target node group {i, j, k} (hereinafter, referred to as node group I) shown in FIG. 4. In FIG. 8A, a point 30 shows representative position coordinates of the node group I, and a circle 32 indicated by the broken line is a circle having a diameter of R centered at the point 30. The node group I is displayed by superimposing the respective nodes so as to be included in the range of the circle 32. In the embodiment, the center position of a node displayed at the center in the abbreviated display target node group is placed so as to overlap with the representative coordinate position of the node group. The other nodes are placed so as to be sequentially separated from the centered node by a constant distance d. This will be specifically described by way of the example in FIG. 8A. The center of the node j which is displayed at the center in the node group I {i, j, k} is placed so as to overlap with the point 30. The node i is placed so as to be separated from the node j by the distance d. The node k is placed so as to be separated from the node j by the distance d in the direction opposite to the node i. As shown in FIG. 8B, in each node, the length of a diagonal line is assumed to 1. In this case, when R<1+(n−1)d is attained according to the initial value of d (n is the number of nodes included in a node group, and n=3 in the above-described example), d is newly calculated by using a condition of d=(R−1)/(n−1). The diameter R may be given as a fixed value, or may vary according to the width of a window to be displayed. The processor 10 performs the above-described processing on all the abbreviated display target node groups which are found by the abbreviated display target node group retrieving section 22, thereby obtaining an output image. Then, the processor 10 stores the output image data obtained by the above processing in the video memory of the graphic interface 14.

The graph display section 28 includes the display 16 of the link relationship display apparatus 1. The processor 10 outputs the image data stored in the video memory of the graphic interface 14 to the display 16, so that the generated bipartite graph image is displayed on the display 16.

Hereinafter, the operation of visualizing processing of network data by the link relationship display apparatus 1 of the embodiment of the invention will be described in detail.

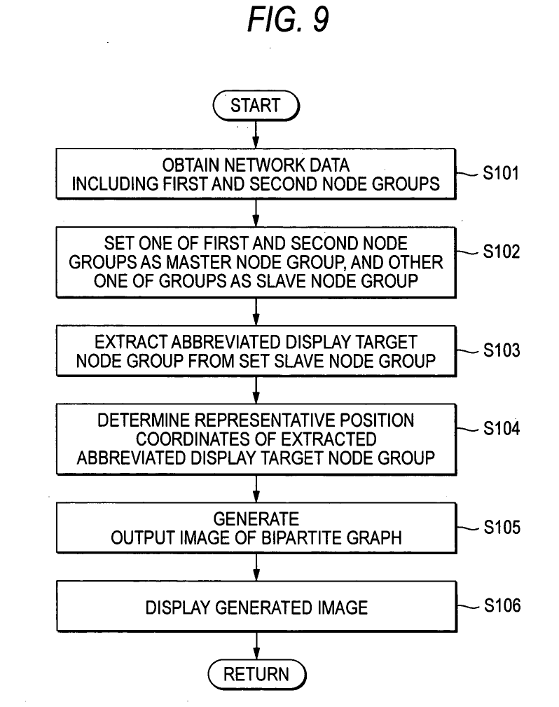

FIG. 9 is a flowchart showing a process in the case where the link relationship display apparatus 1 of the embodiment of the invention generates a bipartite graph. As shown in FIG. 9, the link relationship display apparatus 1 obtains network data indicating a link relationship between a first node group and a second node group (Slol). Then, the link relationship display apparatus 1 sets one of the first node group and the second node group as a master node group, and the other one of the groups as a slave node group on the basis of the obtained network data (S102). The setting of the master node group and the slave node group may be specified by the user, or may be determined in accordance with the numbers of constituting nodes of the first node group and the second node group. The link relationship display apparatus 1 extracts, from the nodes included in the slave node group which is set in step S102, nodes having a degree of link coincidence which indicates a ratio of common nodes in the master node group to be linked, and which exceeds the predetermined threshold, as abbreviated display target node groups (S103). Then, each of the abbreviated display target node groups extracted in step S103 is regarded as one node, and placement coordinates for the nodes included in the network data are obtained (S104). The placement coordinates of the regarded node are used as representative position coordinates of the corresponding abbreviated display target node group. The nodes of the abbreviated display target node group are placed in the vicinities of the representative position coordinates, thereby generating an image of a bipartite graph obtained by performing the abbreviated display processing on network data (S105). The link relationship display apparatus 1 displays an image on the display 16 based on the image data generated in step S105 (S106).

According to the above-described link relationship display apparatus of the embodiment of the invention, even when the number of nodes to be displayed is increased, it is possible to perform the abbreviated display on a node group having a degree link coincidence which is equal to or larger than a predetermined ratio, with respect to the set one of the first node group and the second node group. Therefore, it is possible to show structural characteristics of the network in an easy-to-understand manner.

The invention is not restricted to the above-described embodiment.

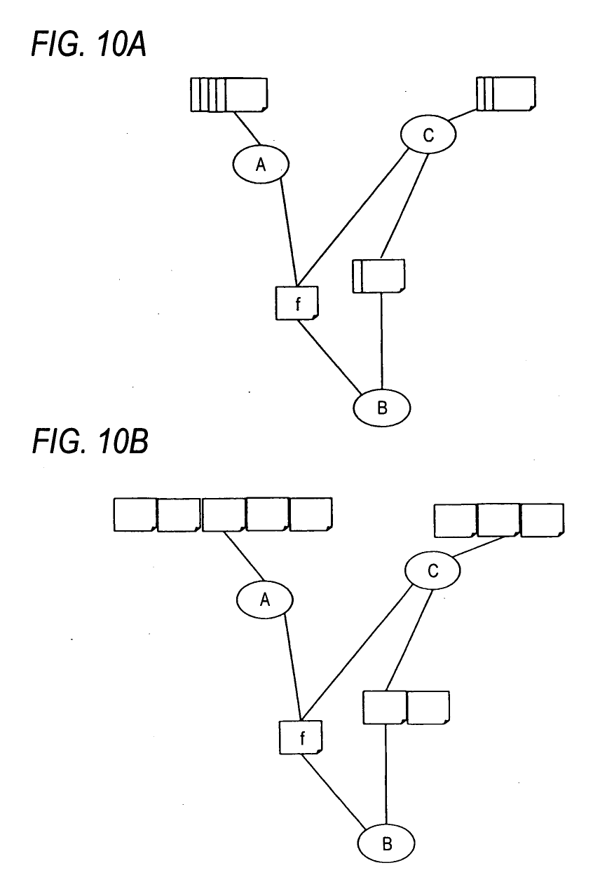

For example, in the above-described embodiment, the nodes of the abbreviated display target node group are displayed with being obliquely superimposed. However, the display may be performed in other various ways. The nodes may be horizontally superimposed as shown in FIG. 10A, or may be arranged adjacently to each other as shown in FIG. 10B.

The entire disclosure of Japanese Patent Application No. 2005-333039 filed on Nov. 17, 2005 including specification, claims, drawings and abstract is incorporated herein by reference in its entirety.

1. A link relationship display apparatus for displaying a link relationship between a first node group and a second node group, each of which includes at least one node, the link relationship display apparatus comprising:
a unit to set one of the first node group and the second node group as a master node group, and another one as a slave node group;
a unit to extract a node of an abbreviated display target node group from the slave node group, the node having a degree of link coincidence which exceeds a predetermined threshold, the degree of link coincidence indicating a ratio of a common node to be linked in the master node group;
a unit to determine a representative position coordinate of the node of the abbreviated display target node group; and
a display unit to display a corresponding abbreviated display target node group in a vicinity of the representative position coordinate.

2. The link relationship display apparatus according to claim 1, wherein the display unit displays the corresponding abbreviated display target node group in a predetermined range of the determined representative position coordinate.

3. The link relationship display apparatus according to claim 1, wherein the display unit displays node included in the abbreviated display target node group arranged at a predetermined interval.

4. A method of controlling a link relationship display apparatus for displaying a link relationship between a first node group and a second node group, each of which includes at least one node, the method comprising:
setting one of the first node group and the second node group as a master node group, and another one as a slave node group;
extracting a nodes of an abbreviated display target node group from the slave node group, the node having a degree of link coincidence which exceeds a predetermined threshold, the degree of link coincidence indicating a ratio of a common node to be linked in the master node group;
determining a representative position coordinate of the node of the abbreviated display target node group; and
displaying a corresponding abbreviated display target node group in a vicinity of the representative position coordinate.

5. A storage medium readable by a computer, the storage medium storing a program of instructions executable by the computer to perform a function for controlling a link relationship display apparatus for displaying a link relationship between a first node group and a second node group, each of which includes at least one node, the function comprising the steps of:
setting one of the first node group and the second node group as a master node group, and another one as a slave node group;
extracting a nodes of an abbreviated display target node group from the slave node group, the node having a degree of link coincidence which exceeds a predetermined threshold, the degree of link coincidence indicating a ratio of a common node to be linked in the master node group;
determining a representative position coordinate of the node of the abbreviated display target node group; and
displaying a corresponding abbreviated display target node group in a vicinity of the representative position coordinate.
